(19) United States
(12) Patent Application Publication
(10) Pub. No.: US 2026/0200302 A1
(43) Pub. Date: Jul. 16, 2026

(54) VEHICULAR BACK DOOR

(71) Applicant: RESONAC CORPORATION, Tokyo (JP)

(72) Inventors: Naoki UKIHASHI, Minato-ku, Tokyo (JP); Masayoshi IWABUCHI, Tagawa-shi, Fukuoka (JP)

(21) Appl. No.: 18/713,965

(22) PCT Filed: Jun. 21, 2023
(86) PCT No.: PCT/JP2023/023027

§ 371 Date: May 28, 2024

(30) Foreign Application Priority Data
Jun. 28, 2022 (JP) 2022-103846

(51) Int. Cl. B60J 5/10

(52) U.S. Cl. CPC B60J 5/107

(57) ABSTRACT

A vehicular back door includes a first panel formed from resin, a second panel formed from resin, an adhesive disposed at a join face of the first panel, and a protrusion that is provided at a join face of the second panel, that protrudes toward the join face of the first panel, and that contacts the adhesive.

### TECHNICAL FIELD The present disclosure relates to a vehicular back door.

### BACKGROUND ART

Hitherto, a back door device formed from resin for closing off an openable/closeable back door opening formed in a rear wall of a vehicular body of a vehicle is known, such as described in Japanese Patent No. 6382563. The body of the back door may be configured by joining an inner panel formed from resin and an outer panel formed from resin together using an adhesive. Often a pre-set inside space is formed between the two panel members that have been joined. Hereafter an inner panel and an outer panel will sometimes be collectively referred to simply as “panel members”.

In an operation to join two panel members together, for example, first an adhesive is disposed on an adhesive placement region pre-set on a join face of one of the panel members. Adhesive is pressed out from inside a nozzle at a leading end of a dedicated tube or hose. Then a join face of the other panel member is caused to approach the adhesive placement region on the surface of the one panel member by movement along a pre-set approach direction.

As a result of this approach, the join face of the other panel member contacts peaks in the adhesive, and the join faces of the two panel members are superimposed on each other. The two panel members are left until the adhesive has dried with their join faces superimposed on each other. The two panel members are joined by the adhesive curing by being left.

Patent Document 1: Japanese Patent No. 6382563

### SUMMARY OF INVENTION

### Technical Problem

In a joining operation, if the join face of a panel member with adhesive disposed thereon is inclined with respect to a horizontal plane, then until the join faces of two panel members have been superimposed on each other, a so-called “crease” might be generated, this being a state in which part of a peak of the disposed adhesive is lower than other parts thereof. A crease may be generated not only due to the join face being inclined, but might also be generated due to a viscosity of the disposed adhesive or due to a coating amount of the adhesive. Namely, at least one factor may be the cause of crease generation from out of a join face being inclined, viscosity of adhesive, or a coating amount of the adhesive.

When a crease is generated this means that the entire join face of the other panel member does not contact the adhesive after the one panel member has been caused to approach the other panel member in the joining operation, leading to a concern that a gap, namely a groove, might be formed between part of the join face and the peak of the adhesive. If the formed groove links through from an outside space of the back door to an inside space, then water such as rainwater readily ingresses into the inside space through the linked groove. Namely, a route for water is formed by the groove communicating through from the outside space to the inside space in the adhesion region of the two panel members.

If water that ingresses through the route for water then lingers in the inside space this readily leads to at least one out of a drop in quality of the panel members or a drop in strength of the join section. Thus Japanese Patent No. 6382563 describes forming a water escape hole in an outer edge of the inner panel at a lower end portion of the back door for external discharge of ingressed water. However, Japanese Patent No. 6382563 does not describe any specific investigations related to ingress of water into the adhesion region of the two panel members caused by creased adhesive during the joining operation.

In consideration of the above circumstances, an object of the present disclosure is to provide a vehicular back door in which waterproofness in an adhesion region of two panel members has been raised.

### Solution to Problem

Specific means to address the above issues are set out below.
<1>

A vehicular back door including:
a first panel formed from resin;
a second panel formed from resin;
an adhesive disposed at a join face of the first panel; and
a protrusion that is provided at a join face of the second panel, that protrudes toward the join face of the first panel, and that contacts the adhesive.
<2>

The vehicular back door of <1>, wherein the protrusion includes a rib extending along an outer edge of the join face of the second panel.
<3>

The vehicular back door of <2>, wherein plural of ribs are disposed in a row in a direction intersecting with a direction along the outer edge.

### Advantageous Effects

The present disclosure is able to provide a vehicular back door in which waterproofness in an adhesion region of two panel members has been raised.

### BRIEF DESCRIPTION OF DRAWINGS

FIG. 1 is a cross-section to explain a vehicular back door according to an exemplary embodiment of the present disclosure.

FIG. 2 is a side view to explain a vehicular body fitted with a vehicular back door according to the present exemplary embodiment.

FIG. 3 is a perspective view to explain a join face of an inner panel provided with protrusions according to the present exemplary embodiment.

FIG. 4A is a diagram to explain a state in which a crease has been generated in a peak of adhesive.

FIG. 4B is a diagram to explain a state in which a groove has been formed between adhesive having a crease generated in a peak thereof and an outer panel.

FIG. 5 is a cross-section to explain a vehicular back door according to a comparative example.

### DESCRIPTION OF EMBODIMENTS

Description follows regarding an exemplary embodiment of the present disclosure. Similar reference numerals are appended to similar portions in the following description of the drawings. However, the drawings are merely schematic, and relations between thickness and plane dimensions, and ratios of thicknesses in each device and each member, differ from actual ratios. This means that the specific thicknesses and dimensions should be determined while referring to the following description. Moreover, there are also portions where the relationship of dimensions and ratios differ from each other between the respective drawings. Moreover, unless explicitly stated otherwise in the present specification, there is no limitation to there being one item of each configuration element in the present disclosure, and there may be plural present thereof.

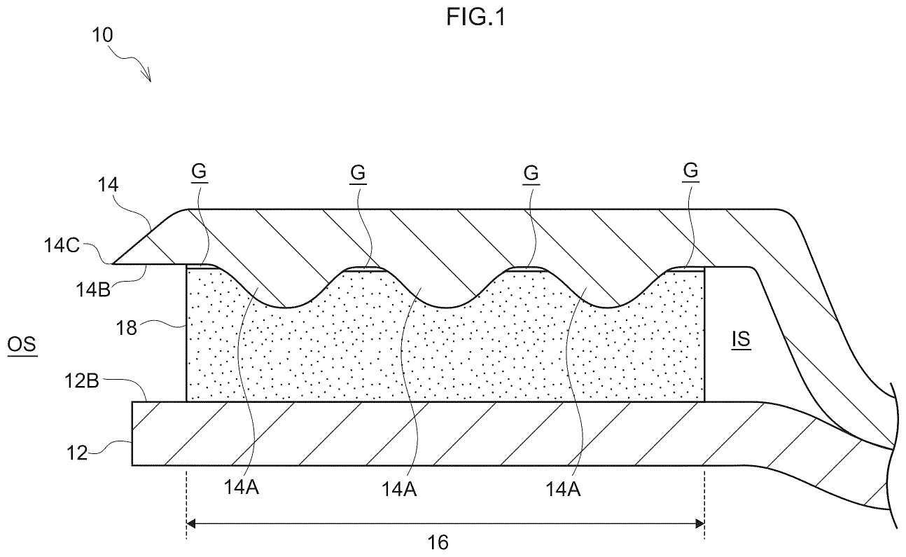

Description follows regarding a vehicular back door 10 according to the present exemplary embodiment, with reference to FIG. 1 to FIG. 4. As illustrated in FIG. 1, the vehicular back door 10 according to the present exemplary embodiment includes a first panel 12, a second panel 14, an adhesive placement region 16, protrusions 14A, and an adhesive 18. Note that for ease of explanation, hereafter vehicular back door is sometimes simply referred to as “back door”.

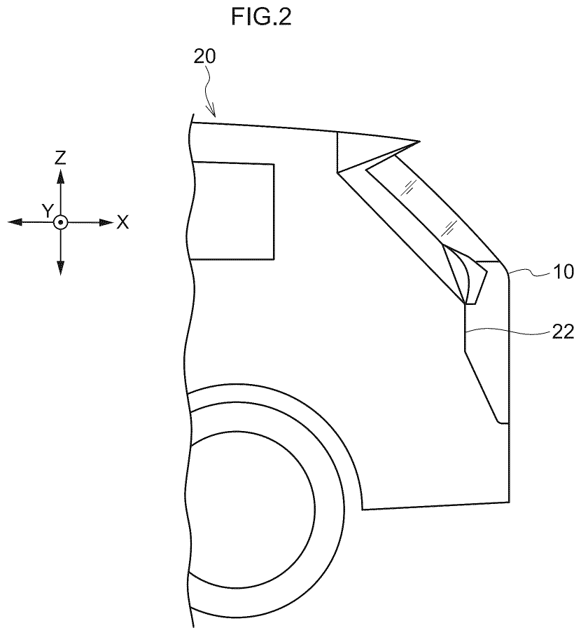

As illustrated in FIG. 2, the back door 10 is provided so as to be capable of opening and closing an opening 22 in a rear section of a vehicular body 20 of a vehicle. In FIG. 2, a front-rear direction X and an up-down direction Z of the vehicular body 20 are each indicated by two directional arrows. A vehicular body 20 width direction Y intersects perpendicularly with both the front-rear direction X and the up-down direction Z.

### Panel Members

The first panel 12 and the second panel 14 are both members that configure the back door 10. Both the first panel 12 and the second panel 14 are made from resin and, for example, may be molded using an injection molding machine. Specifically, a glass fiber composite polypropylene material containing glass fiber at a specific content by weight % may, for example, be employed in the first panel 12. A polypropylene material compounded with talc or rubber may, for example, be employed in the second panel 14.

Note that in the present disclosure the resin material employed to mold the panel members is not particularly limited. The resin employed as the resin material is, for example, preferably at least one resin selected from the group consisting of a polypropylene (PP) resin, a polypropylene composite (PPC) resin, and an Acrylonitrile-Butadiene-Styrene (ABS) copolymer resin.

Although in the present exemplary embodiment the first panel 12 is an inner panel, and the second panel 14 is an outer panel, in the present disclosure the first panel may be an outer panel and the second panel may be an inner panel. Moreover, a shape and plate thickness of the first panel 12 can be freely set according to the desired design. Similarly, the shape and plate thickness of the second panel 14 can be freely set according to the desired design.

### Adhesive Placement Region

As illustrated in FIG. 1, in the present exemplary embodiment the adhesive placement region 16 is pre-set on a surface of a join face 12B of the first panel 12. In the present disclosure the adhesive placement region may be pre-set on a surface of a join face of one out of the first panel 12 or the second panel 14. Moreover, in the present disclosure the shape of the adhesive placement region may be freely set.

### Protrusions

As illustrated in FIG. 1, in the present exemplary embodiment the protrusions 14A are provided at the join face 14B of the second panel 14, i.e. the outer panel, and the protrusions 14A protruded toward the adhesive placement region 16 of the first panel 12, i.e. the inner panel, and contact the adhesive 18.

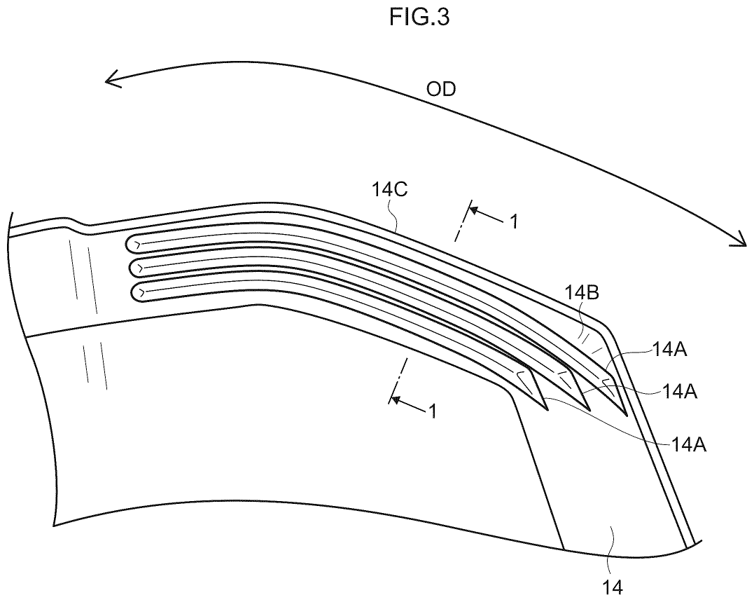

In the present disclosure the protrusions may be provided at the join face of the inner panel and protrude toward the join face of the outer panel. In the present disclosure the protrusions should be provided at the join face of one out of the inner panel or the outer panel, and face toward the join face of the other out of the inner panel or the outer panel. Note that the section plane of the cross-section of FIG. 1 illustrates a state in which the vehicular back door 10 has been sectioned at a position corresponding to a position in the second panel 14 of line 1-1 in FIG. 3. The section plane of line 1-1 is perpendicular to an inner face of the first panel 12.

As illustrated in FIG. 3, the protrusions 14A include ribs extending along part of an outer edge 14C of the join face 14B of the second panel 14. Namely, the ribs of the protrusions 14A of the present exemplary embodiment have a specific length along a left-right direction in FIG. 3. In the present disclosure the shape of the protrusions may be a shape other than a rib and may be freely set such as, for example, in dot shapes. Moreover, in the present disclosure all of the plural protrusions may be ribs, or some of the plural thereof may be ribs.

In the present exemplary embodiment there are three protrusions 14A in a row in a direction intersecting with a direction OD along the outer edge 14C. For example, the cross-section line 1-1 in FIG. 3 is along a direction intersecting with the direction OD. In the present disclosure the number of protrusions may be one, or may be a freely selected plural number of three or more.

### Adhesive

In the present exemplary embodiment the adhesive 18 contacts the entire surface of the ribs of the three protrusions 14A. Namely, the adhesive 18 is disposed in a string shape in the adhesive placement region 16 on the join face 12B of the first panel 12 according to the shape of the ribs of the protrusions 14A as is apparent in FIG. 3. Note that in the present disclosure the adhesive may contact the entire surface of the ribs of the protrusions, or may make partial contact therewith. Moreover, in the present disclosure the adhesive may be disposed in a shape other than a string shape.

### Joining Operation

In an operation to join the two panel members together, first the adhesive 18 is disposed on the adhesive placement region 16 at the join face 12B of the first panel 12. The adhesive 18 may, for example, be disposed in a string shape on the adhesive placement region 16 by being continuously pressed out from inside a nozzle at a leading end of a dedicated tube or hose. Moreover, the join face 14B of the second panel 14 is caused to approach the adhesive placement region 16 of the first panel 12 along a pre-set approach direction.

As a result of this approach, the join face 14B of the second panel 14 contacts peaks in the adhesive 18, and the join faces of the two panel members are superimposed on each other. The two panel members with the join faces superimposed on each other are joined together by the adhesive curing.

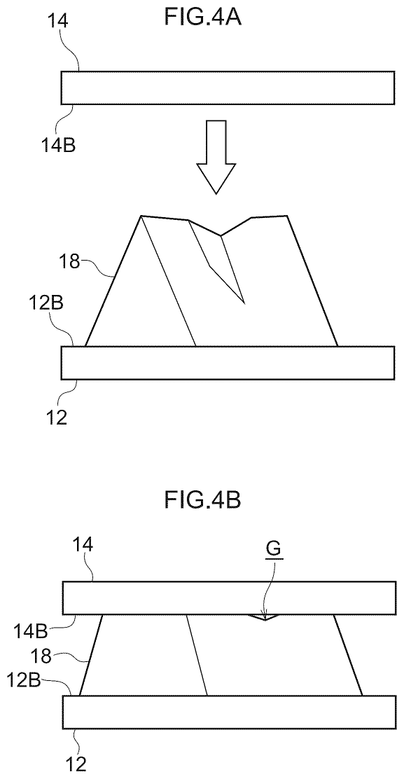

As illustrated in FIG. 4A, in the joining operation, if the join face 12B of the first panel 12 with the adhesive 18 disposed thereon were, for example, to be inclined with respect to a horizontal plane, then a crease would be generated in the peak of the adhesive 18. Thus as illustrated in FIG. 4B, after the second panel 14 has been caused to approach the first panel 12, a groove G is formed between part of the join face 14B and the peak of the adhesive 18, with the whole of the join face 14B of the second panel 14 not in contact with the adhesive 18.

However, in the present exemplary embodiment as illustrated in FIG. 1, the plural grooves G are impeded from linking up with each other by the protrusions 14A. This means that a route for water communicating from an outside space OS of the back door 10 through to the inside space IS is suppressed from being formed.

### Comparative Example

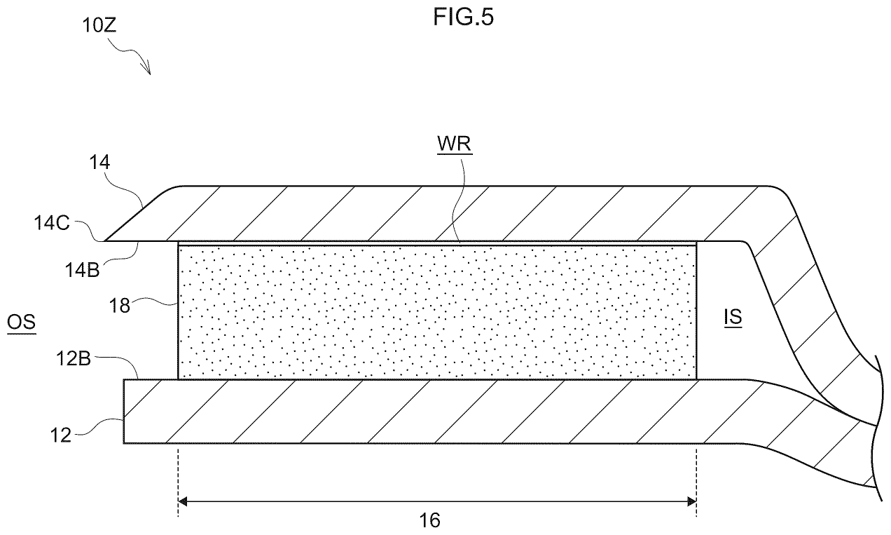

Next, description follows regarding a vehicular back door 10Z according to a comparative example, with reference to FIG. 5. The vehicular back door 10Z according to the comparative example differs from the present exemplary embodiment in the point that there are no protrusions 14A provided to the panel member.

This means that, in the comparative example as illustrated in FIG. 5, after the two panel members have been superimposed there is a route for water WR formed by the groove G communicating from an outside space OS of the vehicular back door 10Z through to the inside space IS. Moreover, the route for water WR is not only formed by a single groove G, but may be formed by plural of the grooves G linking together. As a result thereof, water such as rainwater readily ingresses into the inside space IS of the back door 10Z through the route for water WR that has been formed. If the water that ingresses lingers in the inside space IS, then this readily leads to at least one out of a drop in quality of panel members or a drop in strength of the join section.

### Operation and Advantageous Effects

In the vehicular back door 10 according to the present exemplary embodiment, the protrusions 14A are provided at the join face 14B of the second panel 14 so as to protrude toward the adhesive placement region 16 pre-set on the join face 12B of the first panel 12. The protrusions 14A contact the adhesive 18 disposed on the adhesive placement region 16. This means that a distance between the respective join faces of the first panel 12 and the second panel 14 is shorter at positions of the protrusions 14A, than a distance between the join faces at positions other than the protrusions 14A. Namely, at the position of the protrusions 14A, a thinner thickness suffices for the adhesive 18 needed for joining compared to a thickness of the adhesive 18 needed for joining at positions other than at the protrusions 14A.

This means that even if the height of the adhesive 18 disposed on the adhesive placement region 16 of the first panel 12 is lower due to creases, grooves G between the adhesive 18 and the join face 14B of the second panel 14 can still be suppressed from being formed at the position of the protrusions 14A. As a result thereof a surface area of openings of the grooves G can be reduced. Moreover, as illustrated in FIG. 1, the protrusions 14A are able to impede plural grooves G from linking up with each other. This means that a route for water WR communicating from the outside space OS through to the inside space IS can be suppressed from being formed in the adhesive region. This means that the present exemplary embodiment is able to provide a vehicular back door 10 with waterproofness that has been raised in the adhesive region of the two panel members.

Moreover, in the present exemplary embodiment, the total amount of the adhesive 18 used can be reduced compared to a state in which the protrusions 14A are not provided by an amount commensurate with how much the thickness of the adhesive 18 at the position of the protrusions 14A is thinner than the thickness of the adhesive 18 at positions other than at the protrusions 14A.

Moreover, in the present exemplary embodiment, due to the protrusions 14A being provided at the join face 14B of the second panel 14, the strength of the join section between the second panel 14 and the first panel 12 can be improved compared to a join section not provided with the protrusions 14A.

Moreover, in the present exemplary embodiment, the protrusions 14A provided to the second panel 14 include the ribs extending along the outer edge 14C of the second panel 14. This means that waterproofness to water that ingresses into the adhesive region from the outer edge 14C can be raised even further compared to a state in which the shape of the protrusions 14A is, for example, a dot shape in plan view.

Moreover, in the present exemplary embodiment the three protrusions 14A in the adhesive placement region 16 are arranged in a row along a direction intersecting with the direction OD along the outer edge 14C. Namely, three ribs are arranged in a row between the outside space OS of the back door 10 and the inside space IS present on the other side of the outer edge 14C. This means that waterproofness of the adhesive region can be further raised compared to a state in which the number of the protrusions 14A provided is just one.

### Other Exemplary Embodiments

Although the present disclosure has been described using the exemplary embodiments disclosed above, the statements and drawings that make up part of this disclosure should not be understood as being limitations to the present disclosure.

For example, the present disclosure is not limited to a vehicular back door and is, for example, applicable to adhesion regions of panel portions made from resin in various vehicular components such as a bumper, a side mudguard, a fender, a back door garnish, a spoiler, and a radiator. Moreover, the present disclosure is not limited to vehicular components and is, for example, applicable to adhesion regions of panel portions made from resin configuring various structural bodies other than a vehicle, such as railway equipment or a building. The present disclosure includes various exemplary embodiments not described above, and the technical scope of the present disclosure is determined from the above description by the invention determining matter in the scope of the appropriate patent claims.

The entire content of the disclosure of Japanese Patent Application No. 2022-103846 filed on Jun. 28, 2022 is incorporated by reference in the present specification.

Moreover, all publications, patent applications and technical standards mentioned in the present specification are incorporated by reference in the present specification to the same extent as if each individual publication, patent application, or technical standard was specifically and individually indicated to be incorporated by reference.

### Explanation of the Reference Numerals

10 vehicular back door
10Z vehicular back door
12 first panel
12B join face
14 second panel
14A protrusion
14B join face
14C outer edge
16 adhesive placement region
18 adhesive
20 vehicular body
22 opening
G groove
IS inside space
OD direction along outer edge
OS outside space
WR route for water
X front-rear direction
Y width direction
Z up-down direction

1. A vehicular back door comprising:
a first panel formed from resin;
a second panel formed from resin;
an adhesive disposed at a join face of the first panel; and
a protrusion that is provided at a join face of the second panel, that protrudes toward the join face of the first panel, and that contacts the adhesive.

2. The vehicular back door of claim 1, wherein the protrusion includes a rib extending along an outer edge of the join face of the second panel.

3. The vehicular back door of claim 2, wherein a plurality of ribs are disposed in a row in a direction intersecting with a direction along the outer edge.
